(19) United States
(12) Patent Application Publication
(10) Pub. No.: US 2007/0051798 A1
(43) Pub. Date: Mar. 8, 2007

(54) Content management server, storage medium having content management program stored therein, and content management method

(76) Inventors: Yoshikazu Kawai, Tokyo (JP); Mitsuhisa Kamei, Tokyo (JP)

Correspondence Address: GAUTHIER & CONNORS, LLP, 225 FRANKLIN STREET, SUITE 2300, BOSTON, MA, 02110, US

(21) Appl. No.: 11/353,577

(22) Filed: Feb. 14, 2006

(30) Foreign Application Priority Data
Sep. 6, 2005 (JP) 2005-257277

(51) Int. Cl. G06K 5/00

(52) U.S. Cl. 235/382

(57) ABSTRACT

There is provided a content management server for providing a content to a target user. This server includes a protected content generator which encapsulates an original content to generate a protected content corresponding to the original content, and an accessibility setting unit which sets access right to access the protected content to a user of the content management server.

### PRIORITY INFORMATION

This application claims priority to Japanese Patent Application No. 2005-257277, filed on Sep. 6, 2005, which is incorporated herein by reference in its entirety.

### BACKGROUND

1. Technical Field

The present invention relates to a technique for managing content data such as document data.

2. Related Art

In conjunction with the growing availability of computer network environments, a system including a document management server for managing document data within a local area network is often provided. In such a system belonging to a company, for example, document data managed by the document management server can be employed by company employees from terminals within the company. Management of document data using the document management server is advantageous, in that various types of data can be shared within the company. On the other hand, there are unignorable risks of leaks of confidential information managed by the document management server

The DRM (Digital Rights Management) technique is one known technique of preventing unauthorized use of digital contents such as document data. According to the DRM technique, encapsulation, which is one type of encryption, is performed with respect to a digital content, such that only authorized users can employ the digital content. More specifically, when DRM is used, the digital content itself is encrypted such that even a user having an authorized access right cannot obtain the raw (original) digital data. Accordingly, unauthorized uses, including illegal copying of a content by an authorized user, can be prevented.

However, in a typical, conventional system for managing digital contents, assignment of an accessibility attribute to a digital content usually involves a troublesome operation, such that there are risks of accessibility attributes being set incorrectly.

More specifically, in a typical, conventional system for managing digital contents, when a digital content is to be encrypted, the user himself who manages the content executes encryption processing with respect to the original content by means of a computer or the like, and stores the encrypted and protected content inside a content management server.

Further, access information (access right to the repository) must be set for controlling the content management server to permit a user of the protected content stored inside the content management server to access the protected content.

As such, in a typical, conventional system for managing digital contents, a user who manages a content must generate a protected content, store the generated content inside a content management server, and then set access information related to the protected content. Further, because many steps as described above are required, there are risks that an access right may be assigned to an incorrect user when the access information is set for controlling the content management server.

In light of the above situation, demand has arisen for a technique which facilitates generation of a protected content and allows appropriate assignment of an access right with respect to the generated protected content.

### SUMMARY

The present invention has been conceived in light of the above-described situation, and, according to one aspect, provides a content management server for providing contents to target users. This server includes a protected content generator which encapsulates an original content to generate a protected content corresponding to the original content, and an accessibility setting unit which sets access right to access the protected content to a user of the content management server.

### BRIEF DESCRIPTION OF THE DRAWINGS

Embodiments of the present invention will be described in detail by reference to the following figures, wherein:

FIG. 1 is a diagram showing the overall configuration of a document management system according to an embodiment of the present invention;

FIG. 2 is a flowchart for explaining document management according to the embodiment;

FIG. 3 is a diagram showing an access right setting screen display; and

FIG. 4 is a diagram showing a use condition setting screen display.

### DETAILED DESCRIPTION

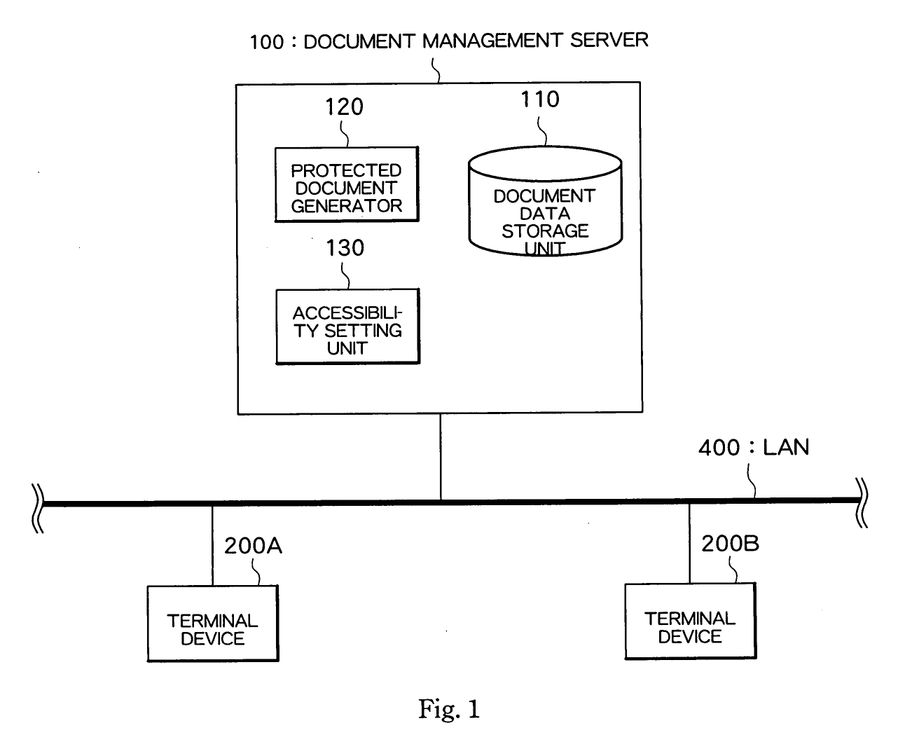

FIG. 1 is a diagram showing one embodiment of the present invention, and illustrates the overall configuration of a document management system including a document management server, which is an example content management server according to the present invention. It should be noted that the contents handled by the content management server of the present invention are not limited to document data. Instead of document data, image data or audio data may be handled. In the present embodiment, document data are referred to as example data handled by the content management server, and a document management system in which document data are exchanged is described by way of example.

The document management system shown in FIG. 1 is configured by connecting a document management server 100 and a plurality of terminal devices 200A and 200B via a LAN (local area network) 400. The document management server 100 and the terminal devices 200A, 200B may alternatively be connected via a public network such as the Internet.

The document management server 100 functions as a repository which manages document data and provides the managed document data to the terminal devices 200A, 200B in accordance with requests from the terminal devices 200A, 200B. Functional blocks within the document management server 100 are depicted in FIG. 1.

The document management server 100 has a hardware arrangement (not shown) including a CPU, memory, and a hard disk. By means of cooperative operation of the hardware arrangement and software (a program) which causes the hardware arrangement to function as the document management server 100, the functions of document data storage unit 110, a protected document generator 120, and an accessibility setting unit 130 are realized. For example, the functions of the protected document generator 120 and the accessibility setting unit 130 can be implemented by means of mainly the CPU and the memory. Further, a memory region within the hard disk may be employed as the document data storage unit 110.

It should be noted that the document management server 100 is not necessarily implemented by means of a single apparatus. A portion of a function, such as that of the document data storage 110, may be provided in an external device connected to the document management server 100 via the LAN 400.

The terminal devices 200A, 200B are devices belonging to the users who employ the document management server 100. Typical examples of the terminal devices 200A, 200B are computers, but portable information terminals such as PDAs (personal digital assistants) may alternatively be used. The document management server 100 of the present embodiment may be accessed by the terminal devices 200A, 200B via a web browser, for example.

In the document management system of the present embodiment, a user operates a browser in the terminal device 200A (or 200B) to log onto the document management server 100 using his user ID, and accesses a document folder managed by the server, so as to acquire (download) or store (upload) necessary document data. The document data is subjected to encapsulation processing in accordance with, for example, an instruction from the originator or owner of the data. Further, accessibility settings are designated in correspondence to each document data and data folder. Accessibility settings include a use condition (access right to be set according to DRM) imparted to a user authorized to use an encapsulated protected document, and an access right (right to access the repository) for controlling the document management server 100 to allow a user to access a protected document.

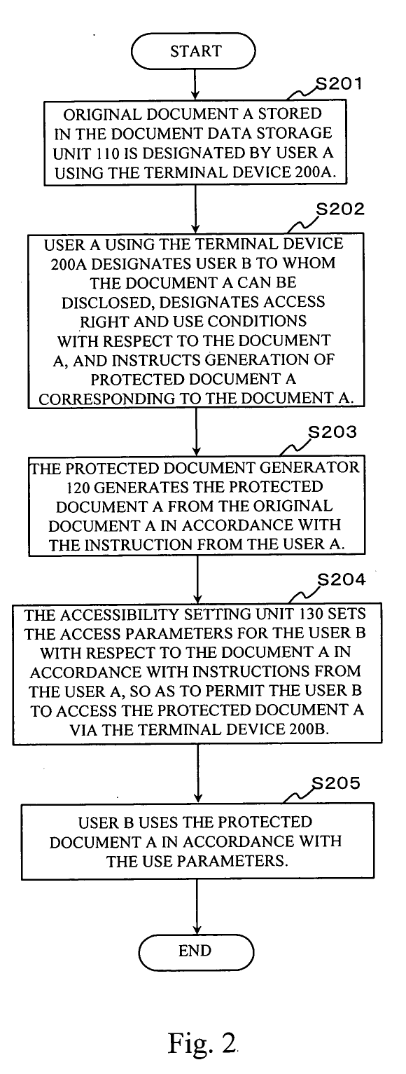

Next, a specific example document management operation according to the document management system of FIG. 1 will be described. FIG. 2 is a flowchart showing a document management process performed by the document management system of FIG. 1. The content of the process is explained step by step by reference to the flowchart of FIG. 2.

In S201, a user A first operates the terminal device 200A to designate an original document A stored in the document data storage 110 of the document management server 100. The original document A is document data managed by the user A, and was stored in advance in the document data storage 110 by the user A. The user A designates the original document A by, for example, selecting the document A within a screen display indicating a list of document data stored inside the document data storage unit 110.

In S202, the user A designates a target user to whom the document A can be disclosed, and also designates access rights and use conditions in relation to the document A. Furthermore, the user A instructs generation of a protected document corresponding to the document A. The designating operations performed by the user A in S202 are executed by means of the terminal device A and via the browser.

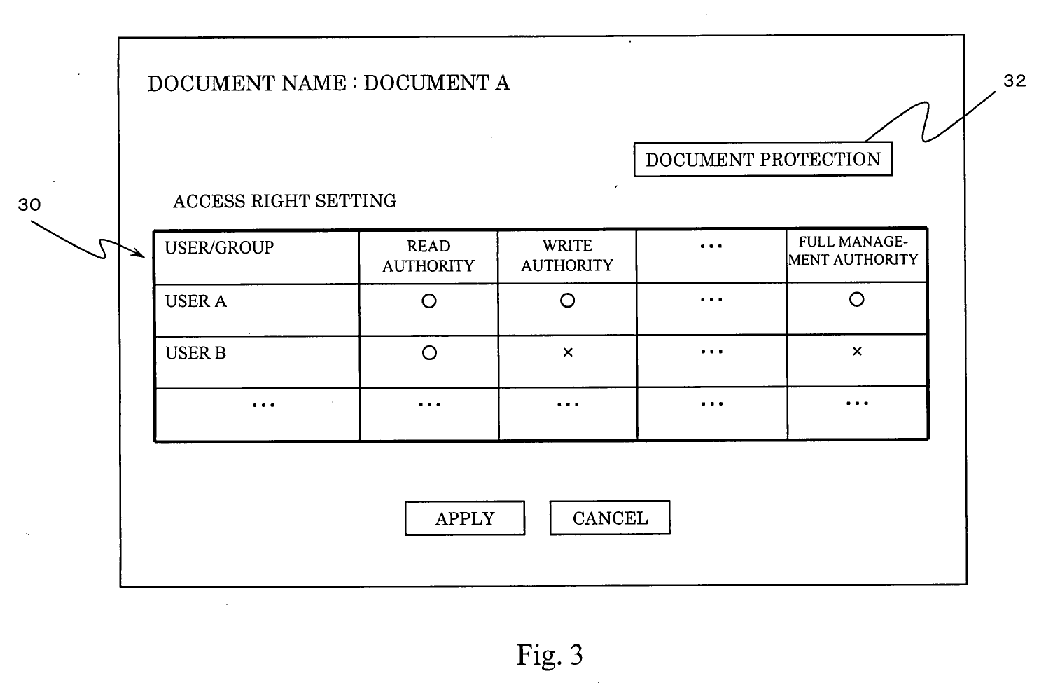

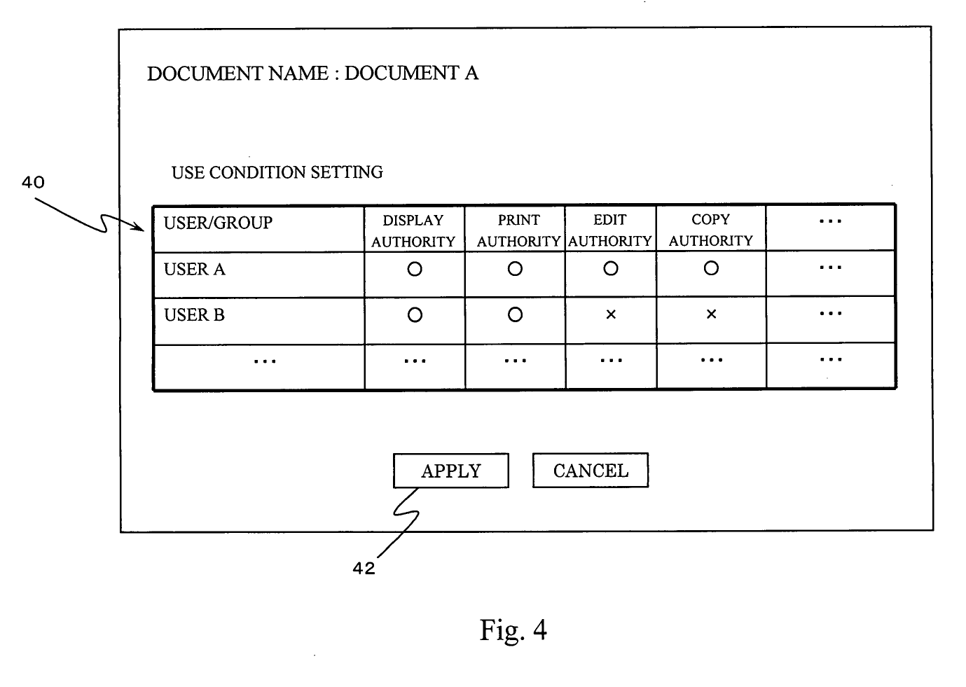

FIGS. 3 and 4 are diagrams showing example browser screen displays provided at the user terminal device. FIG. 3 shows a screen display for setting access rights, while FIG. 4 shows a screen display for setting use conditions.

According to the present embodiment, the user A performs operation, via the browser displayed on the terminal device 200A, to designate the original document A from a screen display of a list of document data stored inside the document data storage unit 110. As a result, a welcome screen concerning settings of the document A is displayed on the terminal device 200A of the user A. Various setting screens for the document A are provided as subordinate screens of the welcome screen. In accordance with operations by the user A, transitions are made from the welcome screen to the various setting screens. The screens shown in FIGS. 3 and 4 are example screens from among the setting screens provided subordinate to the welcome screen for the document A.

The user A operates via the browser provided on the terminal device 200A to designate a target user to whom the document A can be disclosed. During this process, a user list screen indicating multiple users is displayed on the terminal device 200A. When a user B is selected from the user list screen, the user B is designated as a target user to which the document A can be disclosed. When the user B is designated as a target user, a field for the user B is created in an access right setting field 30 shown in FIG. 3. The user list may be displayed below the access right setting field 30.

The user A employs the access right setting screen shown in FIG. 3 to designate access rights of the user B with respect to the document A. The access rights include conditions by which the user B can access the document A managed by the document management server 100. More specifically, as can be seen in the access right setting field 30, parameters such as read authority are included. The user A assigns a right to the user B by performing a designating operation (such as placing a check mark in a check box) in a field corresponding to the right to be assigned within the access right setting field 30. The example of FIG. 3 shows a state in which read authority is assigned to the user B, without imparting write authority or full management authority. When the read authority is assigned, the user B can read out the document A from the document management server 100.

Subsequently, the user A operates the document protection button 32 within the access right setting screen, such that the display screen moves on to the use condition setting screen shown in FIG. 4.

The user A employs the use condition setting screen of FIG. 4 to designate use conditions with respect to the document A. The use conditions define operations which the user B can perform with respect to the document A after reading out from the document management server 100. As shown in a use condition setting field 40, the use conditions include rights such as display authority, print authority, and edit authority concerning the document A. The user A assigns a use condition to the user B by performing a designating operation (such as placing a check mark in a check box) in a field corresponding to the use condition to be assigned within the use condition setting field 40. The example of FIG. 4 shows a state in which display authority and print authority are assigned to the user B, without imparting edit authority or copy authority. When the display authority is assigned, the user B can display the content of the document A on a display unit of the terminal device B after reading out the document A from the document management server 10. Further, when the print authority is assigned, the user B can print out, from the terminal device B and by means of a printer or the like, the content of the document A read out from the document management server 100.

After the user A has designated the use conditions with respect to the document A by means of the use condition setting screen shown in FIG. 4, the user A operates an apply button 42 within the setting screen, so as to instruct generation of a protected document of the document A.

As described above, the user A employs the setting screens shown in FIGS. 3 and 4 in order to designate various settings in S202 of FIG. 2. Returning to the flowchart of FIG. 2, the step-by-step explanation of the process is continued below.

In S203, the protected document generator 120 of the document management server 100 generates a protected document A from the original document A in accordance with an instruction from the user A. More specifically, in response to the operation of the apply button 42 within the setting screen of FIG. 4, the protected document generator 120 executes encapsulation processing with respect to the original document A so as to generate the protected document A corresponding to the original document A.

In S204, the accessibility setting unit 130 of the document management server 100 sets or changes the access rights for the user B with respect to the document A in accordance with instructions from the user A, so as to permit the user B to access the protected document A. In the present example, in accordance with the designation in the access right setting field 30 shown in FIG. 3, read authority with respect to the document A (protected document A) is assigned to the user B. As a result, the document management server 100 provides the protected document A to the user B in response to a request from the user B.

In S205 after the above-described steps, the user B reads the protected document A into the terminal device 200B, and uses the protected document A in accordance with the use conditions. In other words, according to the use conditions set in the setting field 40 of FIG. 4, the user B can perform operations such as displaying the document content of the protected document A on the display unit of the terminal device 200B, and printing the content of the protected document A from the terminal device 200B by means of a printer or the like. When employing the protected document A, the terminal device 200B of the user B acquires an access ticket from a ticket-issuing server (not shown). The access ticket is a decapsulation key corresponding to the encapsulation key used when encapsulating the protected document A, and functions according to the use conditions set for the user B. Using the acquired access ticket, the terminal device 200B can decapsulate the protected document A, but is limited in its operations with respect to the protected document A by the corresponding use conditions set in the access ticket.

In the flowchart of FIG. 2, the user A designates the access rights and use conditions with respect to the document A (in step S202 of FIG. 2). Alternatively, there may be employed a method in which the user A does not designate the access rights with respect to the document A. More specifically, the user A may first designate the use conditions concerning the document A via the use condition setting screen shown in FIG. 4, and then operate the apply button 42 to instruct generation of a protected document of the document A. Subsequently, the accessibility setting unit 130 of the document management server 100 may automatically set the access rights so as to assign the read authority to user B. In this manner, the accessibility setting unit 130 may be configured to automatically set access rights (access rights to the repository) in correlation with the use conditions (access rights set based on DRM) designated by the user A.

Further, while the user A designates the original document A stored within the document data storage 110 of the document management server 100 in step S201 of the flowchart of FIG. 2, the processing after S202 in FIG. 2 performed with respect to the original document A may alternatively be executed at the time when the user A uploads the original document A into the document management server 100.

At a point at which the protected document A is already generated and stored inside the document data storage unit 110, the use conditions of the protected document A can be changed as described below. For example, the user B conveys to the user A his wish to obtain edit authority in addition to the display authority and the print authority. In response, the user A performs operation, via the use condition setting screen of FIG. 4, to change the use conditions of the protected document A, so as to impart edit authority to the user B. When the user A operates the apply button 42 after making the change, the protected document generator 120 of the document management server 100 re-generates protected document A adapted to the changed use conditions. Further, the accessibility setting unit 130 assigns to the user B the read authority with respect to the re-generated protected document A.

At a point after the protected document A is generated and stored inside the document data storage unit 110 and the access rights for the user B are set according to the flowchart of FIG. 2, the access rights can be changed as described below. The user A may perform operation, via the access right setting screen of FIG. 3, to change the access rights of the protected document A, so as to, for example, invalidate the read authority of the user B and newly impart read authority to another user C. In addition, the user A designates, by means of the use condition setting screen of FIG. 4, use conditions for the user C with respect to the protected document A and operates the apply button 42. In response, the protected document generator 120 of the document management server 100 re-generates protected document A in a manner corresponding to the use conditions set for the user C.

Although the protected document A was already generated (in S203) at the time when the user B accesses the document A (in S205) in the flowchart of FIG. 2, the protected document A may alternatively be generated at the point when the user B accesses the document A to download the document A to the terminal device 200B. More specifically, generation of the protected document A (S203) is not performed immediately after the user A finishes designating the access and use conditions of the document A (in S202). Subsequently, at a point when the user B accesses the document A to download the document A, the protected document generator 120 of the document management server 100 generates protected document A in response to the downloading operation, so as to provide the generated protected document A to the user B. In this case, the generated protected document A may be stored within the document management server 100, and may be reused when another request for downloading the document A is received from the user B at a later point.

Although the above description refers to specific examples by which the present invention can be implemented, the present invention may have the following aspects.

According to one aspect of the present invention, there is provided a content management server for providing a content to a target user. This server includes a protected content generator which performs encapsulation processing with respect to an original content so as to generate a protected content corresponding to the original content, and an accessibility setting unit which sets an access right with respect to the protected content so as to permit a target user to access the protected content.

In the above-described server, the content managed by the server may be, for example, document data, image data, audio data, and the like. The content management server may generate the protected content corresponding to the original content in response to an instruction from a user who owns the content. The original content may be managed in advance in the content management server. The protected content may be generated when the user uploads the original content to the content management server. Alternatively, the generation of the protected content may be executed in response to a downloading request, which is received from a target user, for reading out the content from the content management server.

According to the above arrangement, the content management server generates the protected content corresponding to the original content. Therefore, the user does not have to read out the original content from the content management server to generate the protected content using his own computer or the like. Further, the accessibility setting unit sets the access right with respect to the protected content so as to permit a target user to access the protected content. For example, the accessibility setting unit assigns read authority for reading out the protected content from the content management server to a target user correlated with the protected content. In this manner, the read authority is appropriately assigned to the correct target user, thereby avoiding risks of assigning the read authority to an incorrect user.

According to another aspect of the present invention, the protected content may be correlated with a target user who is permitted to use the protected content, and further correlated with a use condition assigned to the target user for using the protected content. The accessibility setting unit assigns read authority for reading out the protected content from the content management server to the target user correlated with the protected content.

According to a further aspect of the present invention, when the use condition of the protected content is changed in accordance with an instruction from the user who owns the content, the protected content generator re-generates a protected content adapted to the changed use condition. Subsequently, the accessibility setting unit assigns read authority for reading out the re-generated protected content from the content management server to the target user who was correlated with the previous protected content before the re-generation.

According to a still further aspect of the present invention, when the access right of the protected content is changed in accordance with an instruction from the user who owns the content, the protected content generator re-generates a protected content adapted to a use condition changed along with the change in the access right. For example, when the target user is changed by the change in the access right, and a use condition appropriate for the changed (new) target user is set, the protected content generator re-generates a protected content which is adapted to the newly set use condition.

According to another aspect of the present invention, there is provided a computer-readable storage medium having stored therein a content management program which causes a computer system to perform a function for managing contents. This function includes performing encapsulation processing with respect to an original content so as to generate a protected content corresponding to the original content, and setting an access right with respect to the protected content so as to permit a target user to access the protected content.

According to a further aspect of the present invention, there is provided a content management method. The method includes performing encapsulation processing with respect to an original content so as to generate a protected content corresponding to the original content, and setting an access right with respect to the protected content so as to permit a target user to access the protected content.

Although a number of embodiments of the present invention have been described above, these embodiments are described by way of example only, and do not serve to limit the scope of the present invention.

What is claimed is:

1. A content management server for providing a content to a target user, comprising:
a protected content generator which encapsulates an original content to generate a protected content corresponding to the original content; and
an accessibility setting unit which sets access right to access the protected content to a user of the content management server.

2. The content management server according to claim 1, wherein
the protected content is correlated with information of a user who is permitted to use the protected content and a use condition for using the protected content; and
the accessibility setting unit assigns right to read out the protected content from the content management server to the user correlated with the protected content.

3. The content management server according to claim 2, wherein
when the use condition of the protected content is changed in accordance with an instruction from a user, the protected content generator re-generates a protected content according to the changed use condition; and
the accessibility setting unit assigns right to read out the re-generated protected content from the content management server to the user who is correlated with the previous protected content before the re-generation.

4. The content management server according to claim 2, wherein
when the access right of the protected content is changed in accordance with an instruction from a user, the protected content generator re-generates a protected content according to a use condition that is changed along with the change of the access right.

5. The content management server according to claim 1, wherein
the protected content generator generates the protected content in response to a download request, which is received from a user, for reading out the content from the content management server.

6. A computer-readable storage medium having stored therein a content management program which causes a computer system to perform a function for managing contents, the function comprising:
encapsulating an original content to generate a protected content corresponding to the original content; and
setting access right to access the protected content to a user of a content management server.

7. The computer-readable storage medium according to claim 6, wherein
the protected content is correlated with information of a user who is permitted to use the protected content and a use condition for using the protected content; and
during setting of the access right, right to read out the protected content from the content management server is assigned to the user correlated with the protected content.

8. The computer-readable storage medium according to claim 7, the function further comprising:
re-generating, when the use condition of the protected content is changed in accordance with an instruction from a user, a protected content according to the changed use condition; and
assigning right to read out the re-generated protected content from the content management server to the user who is correlated with the previous protected content before the re-generation.

9. The computer-readable storage medium as defined in claim 7, the function further comprising:
re-generating, when the access right of the protected content is changed in accordance with an instruction from a user, a protected content according to a use condition that is changed along with the change of the access right.

10. The computer-readable storage medium as defined in claim 6, wherein:
the generation of the protected content is performed in response to a download request, which is received from a user, for reading out the content from the content management server.

11. A content management method, comprising:
encapsulating an original content to generate a protected content corresponding to the original content; and
setting access right to access the protected content to a user of a content management server.

12. The content management method according to claim 11, wherein
the protected content is correlated with information of a user who is permitted to use the protected content and a use condition for using the protected content; and
during setting of the access right, right to read out the protected content from the content management server is assigned to the user correlated with the protected content.

13. The content management method according to claim 12, further comprising:
re-generating, when the use condition of the protected content is changed in accordance with an instruction from a user, a protected content according to the changed use condition; and
assigning right to read out the re-generated protected content from the content management server to the user who is correlated with the previous protected content before the re-generation.

14. The content management method according to claim 12, further comprising:
re-generating, when the access right of the protected content is changed in accordance with an instruction from a user, a protected content according to a use condition that is changed along with the change of the access right.

15. The content management method according to claim 11, wherein:
the generation of the protected content is performed in response to a download request, which is received from a user, for reading out the content from the content management server.
